(19) United States
(12) Patent Application Publication
(10) Pub. No.: US 2024/0043690 A1
(43) Pub. Date: Feb. 8, 2024

(54) BRAN BIOCOMPOSITE AND PRODUCTION METHOD

(71) Applicant: PRODUCTOS ALIMENTICIOS DORIA S.A.S., Mosquera (CO)

(72) Inventors: Pilar ALBALADEJO SÁNCHEZ, Paterna (ES); Miguel Ángel BASTIDAS TORRES, Mosquera (CO); Claudia Patricia COLLAZOS, Mosquera (CO); Miriam GALLUR BLANCA, Paterna (ES); Soraya Carmen SÁNCHEZ BALLESTER, Paterna (ES)

(21) Appl. No.: 18/258,806

(22) PCT Filed: Dec. 15, 2021
(86) PCT No.: PCT/IB2021/061792

§ 371 Date: Jun. 21, 2023

(30) Foreign Application Priority Data
Dec. 23, 2020 (CO) NC2020/0016206

(51) Int. Cl. C08L 99/00; C08K 5/11; C08K 5/00

(52) U.S. Cl. CPC C08L 99/00; C08K 5/11; C08K 5/0008; C08K 2201/005

(57) ABSTRACT

The present invention refers to a biocomposite that incorporates cereal bran as reinforcement material in a polymer matrix, using compatibilizing agents that favor the interaction of said materials. The present invention also refers to the method for producing said biocomposite under controlled operating conditions: Temperature, speed, particle size and moisture, which comprises the steps of heating the polymer matrix, adding a compatibilizing agent and a reinforcement material, cooling the mixture, drying, and granulating, to obtain a product with special physicochemical and mechanical characteristics, like those of conventional plastics.

### FIELD OF THE INVENTION

The present invention is in the industry field of biodegradable materials, packaging of food and non-food products. In particular, the invention is aimed at a biocomposite and its production method.

### BACKGROUND OF THE INVENTION

The current invention trend of circular economies has boosted the demand for biodegradable products that use by-products from industry, so the invention of composite materials that incorporate natural fibers has experienced exponential growth that seek to satisfy the world market demands and mitigate the environmental problems caused by synthetic materials.

In the biocomposite industry, lignocellulosic materials have been described which are used as reinforcements of polymeric matrices to improve the properties of polymers, achieving an increase in rigidity, thermal, and dimensional stability, and barrier properties for production of biocomposites or composite materials.

Strategies aimed at the development of economical and environmentally friendly biodegradable biocomposites have been studied, which use natural fibers as a replacement for artificial fibers in reinforced composites and production processes that allow for improving the mechanical and physicochemical properties of products that incorporate said biocomposite materials.

For example, EP1500683 has addressed methodologies to manufacture biodegradable molded parts from fiber material such as bran or similar, whose particles are subjected to a pretreatment that improves the manufacturing process and quality of the molded part. The biodegradable product disclosed in this document, includes preferably incorporating additives such as binders, which can be biodegradable polymers that together with a bran pretreatment, create a resistant material after compression molding.

On the other hand, US2003/0068427 evaluates materials and processes for manufacturing of biodegradable moldings from bran, wherein the formulation incorporates wheat bran and additives such as fragrances, non-fibrous fillers, moisture-retention agents, colorants that are processed in a two-part mold that is exposed to certain temperature and pressure conditions.

In turn, US20190112479 discloses a composite that incorporates hydrophobic lignin between 0.1 and 90% in a polymer matrix and natural fibers between 30 and 60% as wood fiber and additives. Regarding the method for manufacturing said material, this document discloses the steps of mixing the hydrophobic lignin with the polymer matrix, adding the optional additives, melting a mixture of hydrophobic lignin and a polymer matrix, and extruding the mixture in molten state in a double-screw extruder.

However, the hydrophilic nature of natural lignocellulosic fibers used as reinforcement in biocomposites, differs from the hydrophobic nature of most polymers used as matrix, so the interaction between these two elements is unfavorable. Therefore, there is still a need to develop other alternatives for biodegradable materials with improved physicochemical and mechanical properties, like conventional plastics for application in biodegradable products.

### BRIEF DESCRIPTION OF THE INVENTION

The present invention refers to a biocomposite made up by a polymer matrix, a bran reinforcement, and a compatibilizing agent.

Moreover, the method to produce said biocomposites is developed, which mainly comprises the steps of matrix heating; compatibilizing-agent incorporation; bran-reinforcement addition, cooling, drying, and granulating, speed, moisture and particle size to produce a biomaterial intended to replace conventional plastics to manufacture packagings in general and utensils.

### BRIEF DESCRIPTION OF THE FIGURES

FIG. 1A-B. TG and DTG curve of biocomposites from A. Extrusion-grade PLA/wheat bran/5% Maleic Anhydride (MA) as compatibilizing agent and B. Extrusion-grade PLA/wheat bran/10% Maleic Anhydride (MA) as compatibilizing agent. The effect of the bran concentration variation on the thermal stability is shown.

FIG. 2A-B. TG and DTG curve of biocomposites from A. Extrusion-grade PLA/wheat bran/5% Acetyl Tributyl Citrate (ATBC) as compatibilizing agent and B. Extrusion-grade PLA/wheat bran/10% Acetyl Tributyl Citrate (ATBC) as compatibilizing agent. The effect of the bran concentration variation on the thermal stability is shown.

FIG. 3A-B. TG and DTG curve of biocomposites from A. Extrusion-grade PLA/wheat bran/5% Oligomer Lactic Acid (OLA) as compatibilizing agent and B. Extrusion-grade/wheat bran/PLA/10% Oligomer Lactic Acid (OLA) as compatibilizing agent. The effect of the bran concentration variation on the thermal stability is shown.

FIG. 4. TG and DTG curve of the biocomposites of injection-grade PLA/20% wheat bran/10% Acetyl Tributyl Citrate (ATBC) as compatibilizing agent (red curve) and injection-grade PLA/30% wheat bran/10% Acetyl Tributyl Citrate (ATBC) as compatibilizing agent (blue curve). The effect of the bran concentration variation on the thermal stability is shown.

FIG. 5A-B. DSC curve of the biocomposites of A. Extrusion-grade PLA/wheat bran/5% Maleic Anhydride (MA) as compatibilizing agent and B. Extrusion-grade PLA/wheat bran/10% Maleic Anhydride (MA) as compatibilizing agent. The effect of the bran concentration variation on the thermal stability is shown.

FIG. 6A-B. DSC curve of the biocomposites of A. Extrusion-grade PLA/wheat bran/5% Acetyl Tributyl Citrate (ATBC) as compatibilizing agent and B. Extrusion-grade PLA/wheat bran/10% Acetyl Tributyl Citrate (ATBC) as compatibilizing agent. The effect of the bran concentration variation on the thermal stability is shown.

FIG. 7A-B. DSC curve of the biocomposites of A. Extrusion-grade PLA/wheat bran/5% Oligomer Lactic Acid (OLA) as compatibilizing agent and B. Extrusion-grade PLA/wheat bran/10% Oligomer Lactic Acid (OLA) as compatibilizing agent. The effect of the bran concentration variation on the thermal stability is shown.

FIG. 8. DSC curve of biocomposites of injection-grade PLA/20% wheat bran/10% Acetyl Tributyl Citrate (ATBC) as compatibilizing agent (red curve) and injection-grade PLA/30% wheat bran/10% Acetyl Tributyl Citrate (ATBC) as compatibilizing agent (blue curve). The effect of the bran concentration variation on the thermal stability is shown.

FIG. 9A-C. Mechanical properties of biocomposites of extrusion-grade PLA, wheat bran and Maleic Anhydride (MA) as a compatibilizer. A. Maximum stress (MPa), B. Young's Modulus (GPa) and C. Elongation at break (%).

FIG. 10A-C. Mechanical properties for extrusion-grade PLA, wheat bran and Acetyl Tributyl Citrate (ATBC) biocomposites as compatibilizer. A. Maximum stress (MPa), B. Young's Modulus (GPa) and C. Elongation at break (%).

FIG. 11A-C. Mechanical properties for extrusion-grade PLA, wheat bran and Oligomer Lactic Acid (OLA) biocomposites as compatibilizer. A. Maximum stress (MPa), B. Young's Modulus (GPa) and C. Elongation at break (%).

FIG. 12A-C. Mechanical properties for injection grade PLA, wheat bran and Oligomer Lactic Acid (OLA) biocomposites as compatibilizer. A. Maximum stress (MPa), B. Young's Modulus (GPa) and C. Elongation at break (%).

FIG. 13. Comparison of TG and DTG curves of the references obtained at laboratory scale 8 (extrusion-grade PLA/20% bran/10% ATBC), 16 (injection-grade PLA/30% bran/10% ATBC) vs those obtained on a pilot-scale Ext Biocomposite (extrusion-grade PLA/20% bran/10% ATBC), Inj Biocomposite (injection-grade PLA/25% bran/10% ATBC) vs extrusion-grade PLA and injection-grade without additives.

FIG. 14A-C. Comparison of results of the tensile test on the samples injected at laboratory scale vs pilot scale A. Maximum stress, B. Young's modulus and C. Elongation at break.

### DETAILED DESCRIPTION OF THE INVENTION

Biocomposites

The present invention corresponds to a biocomposite. It is understood that biocomposite is a material made up of at least two phases, wherein one comprises a matrix and the other a natural fiber reinforcement, wherein the first phase is a matrix based on a polymeric material. The second phase is a material that acts as a reinforcement of natural fibers that allows for increasing the mechanical properties, thermal stability, and barrier of the polymer matrix as conventional material.

It is understood that the polymer matrix for the purpose of this invention is a polymer, defined as large molecules (macromolecules) made up from repeated binding of smaller molecules (monomers) by means of covalent bonds or a biopolymer, which is defined as a material from renewable sources (bio-based), which can be generated by biological systems or chemically synthesized from materials of renewable origin. Moreover, the polymer matrix is characterized in that it is resistant to aqueous and fat products, maintains torsion, and high transparency.

The polymer matrix can be from, but is not limited to, renewable sources, generated by biological systems or chemically from materials of renewable origin. In other words, the polymer matrix can be of natural or synthetic origin. In particular, when the polymer matrix is synthetic, it is selected from, but is not limited to, polymers of synthetic origin such as polylactic acid (PLA), polycaprolactone (PCL), polybutylene succinate (PBS), polyhydroxyalkanoate (PHA), when the polymer matrix is of natural origin (biopolymer) selected from the group comprising starch, cellulose, chitosan. In a preferred embodiment, the polymer matrix is a biopolymer, more preferably PLA. The polymer matrix is found in the biocomposite between 30 and 94% w/w, between 60 and 85% w/w or between 60 and 75% w/w.

In another embodiment, the polymer matrix is selected according to the grade based on the application of the final product. Preferably, the polymer matrix is characterized as being extrusion-, injection- or compression-molding grade and more preferably useful in extrusion-thermoforming applications. The polymer matrix is characterized in that it crystallizes during processing. The extrusion-grade or injection-grade polymer matrix has properties such as tensile modulus of approximately 3500 MPa±1000, tensile strength between 40 and 50 MPa and elongation at break <5% or <6%. In particular, for injection applications, the polymer matrix is characterized in that it has a heat deflection temperature of less than 49° C.

Optionally, the polymer matrix has been treated to eliminate the maximum amount of moisture in its composition. In particular, the polymer matrix has a maximum moisture of 250 ppm.

On the other hand, it is understood that the reinforcement material that makes up the second phase of the biocomposite of this invention is a natural lignocellulosic compound made up from biodegradable and plant-origin fibers. This reinforcement material serves as a replacement for synthetic fibers such as glass and carbon and provides reinforcement to the polymer matrix. The reinforcement material improves the conventional properties of the polymer matrix such as increased rigidity, thermal and dimensional stability, and barrier properties, while fulfilling the function of providing structural support, impermeability, and resistance against microbial attack and oxidative stress.

Said reinforcement material is characterized in that it comprises low-density fibers, understanding as low-density fibers those with values between 200 and 400 kg/m³, high strength due to its lignin content (insoluble lignin (TAPPI T222 om-98) of 11.77±0.66), biodegradable, compostable, defined (in accordance with EN 13432 standard (Packaging. Requirements for packaging recoverable through composting and biodegradation. Test scheme and evaluation criteria for the final acceptance of packaging) as aerobically biodegradable, wherein 90% of the material must biodegrade within 180 days). Preferably, the reinforcement material corresponds to by-products of cereal transformation, e.g., cereal bran. It is understood that bran or husk is the result of a part of cereal grain milling. In particular, it comes from the five outermost layers of the grain, made up by a first outer shell or cuticle layer, the second or epicarp, the third or endocarp, the fourth layer called testa, and the fifth called aleurone.

Cereal bran is selected from the group comprising, but not limited to, oat bran, spelt bran, rice bran, rye bran, wheat bran, corn bran, millet bran, bulgur bran, barley bran, quinoa bran, amaranth bran or mixtures thereof. Preferably, the reinforcement material is wheat bran. The reinforcement material is found in the biocomposite between 1 and 70% w/w, between 1 and 30% w/w, or between 10 and 30% w/w.

Usually, natural lignocellulosic fibers used as reinforcement material in composite materials (composites or biocomposites) generate low compatibility between the natural fiber and the polymer matrix. The moisture absorption is relatively high due to the hydrophilic nature of natural lignocellulosic fibers compared to the hydrophobic nature of most polymers used as polymer matrix. In this sense, it is essential to seek to improve the adhesion of the reinforcement material-polymer matrix, so it is necessary to limit water absorption of fibers before their incorporation into the matrix. In the present invention, compatibilizing agents are used to modify the surface of natural lignocellulosic fibers used as reinforcement material and thus promote the improvement of interaction between the reinforcement material and the polymer matrix, its dispersion degree, and therefore the final properties of the biocomposite while these depend directly on the compatibility between the polymer matrix and the reinforcement material.

A high compatibility between the polymer matrix and the reinforcement produces an improvement in the final properties of the biocomposite. On the other hand, if the compatibility between both components is low, a homogeneous dispersion of the reinforcement in the polymer matrix is not achieved, producing a material with poor final properties. For example, due to the different polarity between a PLA polymer matrix and a cereal bran reinforcement material, the compatibility between PLA and bran is low. Therefore, in the present invention, different ways have been proposed to improve compatibility between them.

The present invention proposes the direct chemical modification of cereal bran with a compatibilizing agent to improve said compatibility between the polymer matrix and the reinforcement material. This direct chemical modification has the purpose of increasing the hydrophobic character of cereal bran, thus improving its interaction with the polymer matrix. The chemical modification of cereal bran consists in the substitution of the hydroxyl groups of the cereal bran structure by other less hydrophilic chemical groups from the compatibilizing agent, which reacts with the free —OH groups of the cereal bran structure.

As a second strategy, the present invention proposes the use of compatibilizing external agents to improve the interaction and therefore the dispersion of cereal bran in the polymer matrix. For purposes of the present invention, it is understood that a compatibilizing agent is the substance used to facilitate the mixture of various polymers. In particular, its chemical definition refers to any substance that favors adherence or compatibility from the physicochemical point of view between the polymer matrix and the reinforcement (cereal bran). For example, the compatibilizing agent can be selected from the group comprising Maleic Anhydride (C₄H₂O₃—MA), Acetyl Tributyl Citrate (ATBC) and Oligomeric Lactic Acid (OLA). The compatibilizing agent is found in the biocomposite between 1 and 20% w/w, between 5 and 15% w/w and between 8 and 12% w/w.

Moreover, the biocomposite can incorporate other optional components as additives, which in the context of the present invention can correspond to agents selected from the group that comprises dyes, plasticizers, processing aids, flame retardants, and chemical compatibilizers. These optional components can have the purpose of improving mechanical, physical, chemical, and aesthetic properties.

In an embodiment, the biocomposite comprises PLA as a polymer matrix, wheat bran as a reinforcement material, and ATBC as a compatibilizing agent. In a preferred embodiment, PLA is incorporated between 60 and 75% w/w of the biocomposite, the wheat bran between 10 and 50% of the biocomposite and the ATBC between 5 and 30% of the biocomposite.

In an embodiment, the biocomposite comprises PLA as a polymer matrix, wheat bran as a reinforcement material, and ATBC as a compatibilizing agent. In a preferred embodiment, PLA is incorporated between 60 and 75% w/w of biocomposite, wheat bran between 10 and 30% of the biocomposite and ATBC between 5 and 15% of the biocomposite.

The biocomposite is characterized in that it has improved mechanical, thermal stability and barrier properties. The biocomposite is characterized in that it has a melt-mass flow rate (MFR) between 6 and 15 g/10 min, a melt volume index (MVI) between 6 and 13 cm³/10 min, a melt density between 1 and 1.3 g/cm³, a degradation onset temperature Tₒₙₛₑₜ between 200 and 240° C., and a maximum degradation temperature Tₘₐₓ between 270 to 380° C.

Biocomposite Production Method

The present invention is also related to the biocomposite production method. The biocomposite production method can be performed in a twin-screw extruder. The biocomposite production method comprises heating the polymer matrix until the molten matrix is obtained, adding a compatibilizing agent and a reinforcement material, then cooling the mixture, drying, and granulating the biocomposite to obtain pellets.

The moisture reduction of the polymer matrix can be performed in a step prior to heating or directly on heating. In this first step of heating, the polymer matrix is subjected to a temperature increase that usually goes from room temperature (20 to 30° C.) up to the optimum temperature to achieve melting of the material. In general, the polymer matrices that can be used in the invention have a melting temperature that goes above 160° C. or at a temperature between 165 and 170° C. This heating can be performed in any equipment known to a person of ordinary skill in the art, e.g., in an oven, dynamic heater, industrial compounding machine or extruder.

Then, the addition of the compatibilizing agent (in a ratio between 5 and 15%) and the reinforcement material (in a ratio between 10 and 30%), are performed at a temperature between 170 and 180° C., preferably between 165 and 170° C. and are respectively incorporated into the molten matrix (polymer matrix in a ratio between 60 and 75%), until they form a homogeneous mixture that comes out of the extruder in the form of thread or filament. The stirring speed to obtain the homogeneous mixture is between 250 and 350 rpm, preferably between 300 and 350 rpm. In an embodiment, a gravimetric screw feeding equipment is used for this process, as a satellite equipment of the twin-screw extruder.

The thread cooling comprises lowering the temperature from between 160 and 180° C. to room temperature between 20 and 40° C. This cooling can be performed with air or water, or a combination thereof, particularly, by air injection or in a process of immersion in a water bath, wherein the water is, e.g., between 30 and 40° C. The thread passes through the water bath or remains with air injection for as long as it is necessary for its cooling. The tempered biocomposite is obtained in the form of a thread at temperatures between 20 and 40° C.

When water cooling is performed, the biocomposite is preferably dried, wherein moisture is reduced between 50 and 80% of the initial moisture.

Then, the formation of pellets is performed wherein the thread made up from the homogeneous mixture between the polymer matrix, bran, and compatibilizing agent is transformed into pellets. Pellets can have any size suitable for their processing in further processes such as extrusion or injection. Size and shape of pellets depend on the cutting equipment, the thread shape and/or its function. Pellets can have any shape, e.g., filament, sphere, hemisphere, flat, round, cylindrical, rounded but flat, among others. Diameter or length of pellets may vary or be uniform, between 1 and 10 mm, between 2 and 5 mm or preferably 3 mm.

In a preferred embodiment, the compounding process (mixing of compounds) is performed in a co-rotating twin-screw extruder with a specific screw diameter and length-diameter (L/D) ratio depending on capacity. The twin-screw extruder is equipped with two gravimetric dispensers to feed the granulated polymer and dose the powder additives, and a dispenser for liquids to add the compatibilizing agent.

In a preferred embodiment, the incorporation of each of the components is performed at different temperature conditions so that the bran dispersion is as homogeneous as possible in the compounding process, the compatibilizing agent is effective, and the final material is not degraded. In particular, the production method of the biocomposite comprises the steps of heating the polymer matrix at a temperature between 140 and 190° C. until the molten matrix is obtained, then the compatibilizing agent is added at a temperature between 140 and 200° C. and the bran reinforcement is added keeping the same temperature between 140 and 200° C., all this at a speed between 100 and 350 rpm. The temperature in the mixture is then lowered to room temperature (20 to 30° C.) and the biocomposite is granulated to obtain pellets.

Bran Conditioning

In a preferred embodiment, prior to extrusion processing of the biocomposite, a method is performed for bran conditioning in terms of moisture and particle size to reduce said parameters as much as possible.

In particular, the process of obtaining bran has the product of cereal milling as input, reducing the particle size using a cutting mill, wherein the product is sent to sieves that classify it into different sizes, the sieves have a range between 0.1 and 0.7 mm until obtaining a bran with a particle size of less than 400 μm or between 250 and 400 μm.

Then, the product passes through a series of meshes until the product reaches a homogeneous granulometry (between 50 and 90%) of the total sample processed.

Subsequently, the product goes through a friction and heating process to separate the shell from the endosperm.

Once the particle size has been reduced to the desired granulometry, it is subjected to a dehumidification process wherein the moisture is removed from the bran. This dehumidification process is performed by means of forced heating, e.g., by air injection with a temperature greater than 90° C. or heat transfer by static convection under vacuum. The bran is dried until reaching a residual moisture or intrinsic water between 1 and 5%, preferably equal to or less than 3%.

Uses

The biocomposite obtained is useful to manufacture packagings, containers, cutlery, trays and in general for the purpose of packing or wrapping, storage, and containing liquid, solid and gas materials. Moreover, it is useful to manufacture utensils in general, such as table utensils, wherein for the purposes of the present invention, said uses are not limited to grocery or food industry applications, since they also include uses in the cleaning sectors, cosmetic, pharmaceutical and food industries.

### EXAMPLES

### Example 1. Wheat Bran Conditioning

For biocomposite processing, the prior conditioning of wheat bran used as reinforcement is necessary. This conditioning is performed in terms of moisture and particle size as shown below:
Wheat bran milling: The size distribution of wheat bran obtained as a by-product in milling production is 70%<500 μm and 30%>500 μm. In order to increase the specific surface of wheat bran and avoid its degradation process during biocomposite processing, the particle size is reduced to a size between 250 and 400 μm.
Separation of endosperm and wheat husk: Using equipment for classifying the products derived from wheat milling, which through centripetal force pass through a series of meshes until the product reaches a homogeneous granulometry (between 70 and 90%) in most of the processed sample.
Separation and cleaning process: From the previous step, the product is transported by means of gravity to equipment used for applying sufficient friction to the product and starting a process of heating and shell detachment with the other proteins comprised in the by-product.
Impact classification process: The product is delivered to the impact classification process, which is responsible for accelerating the product against a rotor and impacts the bran, generating the separation of residues along with the organic load, which contributes to cleaning the product and improving the process.
Wheat bran drying process: Based on the following features:
   Initial moisture: Between 11% and 14%
   Granulometry: 250 and 350 μm (60 to 80%).
The product is unloaded in a hopper for transport to the conditioning tank and start of the heat transfer process (drying) by convection model.
Internally, the product begins the temperature rising phase up to 110° C. and is stirred at 45 rpm by a central axis that contains directional paddles and move the product throughout the drying process for approximately 1 hour. Heat transfer is performed by means of heating (electric resistances) of thermal oil located on the external side of the tank. Also, hot air (greater than 70° C.) is injected to atmospherically control the product drying. The product is exposed for approximately 1 hour to the thermal radiation produced by the resistances and conducted by the thermal oil, causing moisture loss.

Bran moisture represents an important factor as it has influence on the final properties of the biocomposites produced, since it could degrade the polymer matrix if the bran percentage in the formulation is very high (>30% bran). For this reason, less than 5% humidity must be controlled.

### Example 2: Drying of PLA Polymer Matrix

The material selected as the polymer matrix is polylactic acid (PLA), a highly hygroscopic aliphatic polyester understood as >100 calories/hour at 20° C. in an open atmosphere. Therefore, it must be considered that for its process, the PLA matrix needs to be previously dried, since the moisture in its structure can react with the molten polymer during processing. This reaction would cause a hydrolytic degradation of said components and, therefore, a loss of molecular weight, which can cause a decrease in properties such as tensile and impact strength.

PLA drying was performed under controlled conditions in a dry-air dehumidifier, and the final moisture of the resin was determined using the Karl-Fischer titration method.

In order to ensure that the processing conditions were adequate, the material was subjected to a 3 to 5-hour drying process between 60 and 100° C., accepting a value between 150 and 300 ppm as the maximum moisture value required for processing.

### Example 3: Laboratory-Scale Processed Formulations

As a reinforcement in the biocomposites, the wheat bran obtained as a residue in the milling production processes was used, i.e., from the grinding of wheat grain to extract approximately 76% endosperm and 24% bran. The latter is key for developing biocomposites, according to the one described in Example 1. The percentage of wheat bran added into the polymer matrix corresponded to 10, 15, 20, 25 and 30%.

The polymer matrix to develop the biocomposite is a polylactic acid (PLA) matrix, according to the one described in Example 2. In this sense, two different grades of PLA were used based on the final packaging application that would be given to the developed biocomposite, on the one hand extrusion-thermoforming, and injection on the other.

For the extrusion-thermoforming application, an extrusion-grade PLA polymer matrix was used, and injection-grade PLA was used for the injection application.

In order to improve the compatibility between wheat bran reinforcement and the PLA polymer matrix, Maleic Anhydride (MA), Acetyl Tributyl Citrate (ATBC) and Oligomer Lactic Acid (OLA) were used as compatibilizing agents from commercial lactic acid (Mn=60500 g/mol). Two percentages were tested for each of them: 5 and 10%.
Biocomposite formulations for extrusion-thermoforming application

TABLE 2
Biocomposites processed by extrusion-thermoforming
based on Bran and MA as compatibilizing agent

| | Wheat bran | Compatibilizing |
|---|---|---|
| No. | reinforcement | agent |
| 1 | 10% | 5% MA |
| 2 | 10% | 10% MA |
| 3 | 15% | 5% MA |
| 4 | 20% | 5% MA |
| 5 | 20% | 10% MA |
| 6 | 30% | 5% MA |

TABLE 3
Biocomposites processed by extrusion-thermoforming
based on Bran and ATBC as compatibilizing agent

| | Wheat bran | Compatibilizing |
|---|---|---|
| No. | reinforcement | agent |
| 7 | 20% | 5% ATBC |
| 8 | 20% | 10% ATBC |
| 9 | 30% | 5% ATBC |
| 10 | 30% | 10% ATBC |

TABLE 4
Biocomposites processed by extrusion-thermoforming
based on Bran and OLA as compatibilizing agent

| | Wheat bran | Compatibilizing |
|---|---|---|
| No. | reinforcement | agent |
| 11 | 20% | 5% OLA |
| 12 | 20% | 10% OLA |
| 13 | 30% | 5% OLA |
| 14 | 30% | 10% OLA |

Biocomposite formulations for injection application

TABLE 5
Biocomposites processed by injection based on Bran
and ATBC as a compatibilizing agent

| | Wheat bran | Compatibilizing |
|---|---|---|
| No. | reinforcement | agent |
| 15 | 20% | 10% ATBC |
| 16 | 30% | 10% ATBC |
| 17 | 20% | 5% ATBC |
| 18 | 30% | 5% ATBC |

### Example 4: Thermal Properties of Biocomposites Developed at Laboratory Scale

Biocomposites developed for extrusion-thermoforming application.
   a. Thermogravimetric Analysis (TGA)

TGA analysis of all samples for extrusion-thermoforming and injection application was performed in a thermogravimetric analyzer (TGA) Q5000 IR (TA Instruments®), in order to measure the mass variation of the sample tested when it is subjected to temperature changes for a certain time under a controlled atmosphere and to predict its thermal stability at temperatures up to 1000° C. due to decomposition, oxidation or dehydration phenomena.

Samples between 3 and 6 mg were used and processed under an initial nitrogen atmosphere and subsequent oxygen, initial temperature of 25° C., and subsequent ramp of 20° C./min up to 900° C. and an isotherm at 900° C. for 10 minutes.

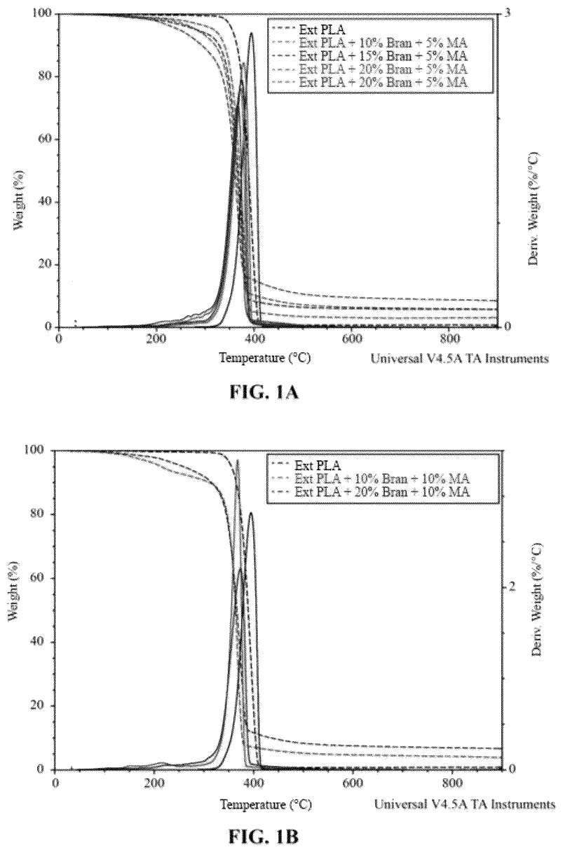

FIGS. 1 to 3 show thermograms of wheat bran and curves corresponding to the first derivative. In particular, FIGS. 1A and B show TG and DTG curves of the extrusion-grade PLA, wheat bran and MA biocomposites in concentrations of 5 and 10%, respectively. Table 6 below compares the main thermal parameters evaluated, degradation onset temperature (Tₒₙₛₑₜ), maximum degradation temperature (Tₘₐₓ), total weight change produced (ΔW) and residue at the maximum induced temperature (% residue).

TABLE 6
Thermal parameters of extrusion-grade
PLA/Bran/MA biocomposites

| | Tₒₙₛₑₜ | Tₘₐₓ | ΔW | % |
|---|---|---|---|---|
| No. | (° C.) | (° C.) | (%) | residue |
| Extrusion- | 371 ± 0 | 393 ± 2 | 99.0 ± 0.2 | 0.92 ± 0.14 |
| grade PLA | | | | |
| 1 | 354 ± 2 | 381 ± 3 | 96.8 ± 0.1 | 3.07 ± 0.00 |
| 2 | 354 ± 2 | 373 ± 8 | 88.0 ± 0.5 | 4.48 ± 0.61 |
| 3 | 345 ± 3 | 369 ± 8 | 94.2 ± 0.4 | 5.30 ± 0.67 |
| 4 | 344 ± 0 | 372 ± 0 | 93.6 ± 0.2 | 6.05 ± 0.22 |
| 5 | 345 ± 0 | 374 ± 0 | 92.5 ± 0.2 | 7.03 ± 0.27 |
| 6 | 337 ± 1 | 367 ± 0 | 90.7 ± 0.0 | 8.77 ± 0.04 |

It is evident that TGA results do not show any improvement in the thermal stability of bran biocomposites when using Maleic Anhydride (MA) as a compatibilizing agent. The increase in MA concentration, from 5 to 10% in the biocomposite, does not produce an improvement in thermal stability either.

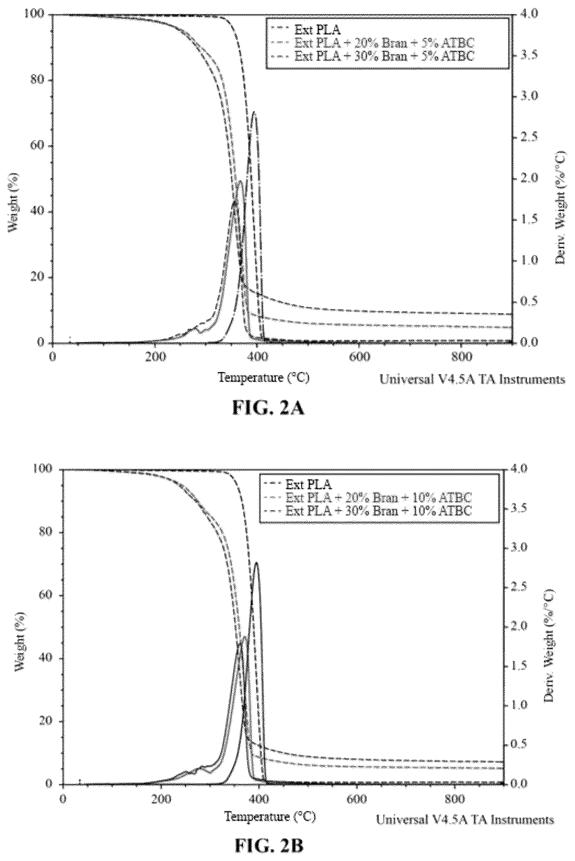

On the other hand, the addition of ATBC as a compatibilizing agent was tested. FIGS. 2A and B show TG and DTG curves of the extrusion-grade PLA and wheat bran biocomposites compatibilized with 5 and 10% Acetyl Tributyl Citrate (ATBC), respectively.

Thermal parameters extracted from the thermograms are compared below:

TABLE 7
Thermal parameters of extrusion-grade
PLA/Bran/ATBC biocomposites

| | Tₒₙₛₑₜ | | | |
|---|---|---|---|---|
| No. | (° C.) | Tₘₐₓ (° C.) | ΔW (%) | % residue |
| Extrusion- | 371 ± 0 | 393 ± 2 | 99.0 ± 0.2 | 0.92 ± 0.14 |
| grade PLA | | | | |
| 7 | 238 ± 1 | 277 ± 2/369 ± 2 | 94.5 ± 0.3 | 4.82 ± 0.20 |
| 8 | 230 ± 2 | 277 ± 2/365 ± 9 | 94.2 ± 0.0 | 5.09 ± 0.21 |
| 9 | 220 ± 14 | 260 ± 11/359 ± 5 | 91.3 ± 1.3 | 8.07 ± 1.33 |
| 10 | 209 ± 2 | 250 ± 3/361 ± 0 | 92.0 ± 0.2 | 7.50 ± 0.20 |

The use of ATBC as a compatibilizing agent in extrusion-grade PLA/wheat bran biocomposites does not improve their thermal stability compared to unreinforced PLA matrix. Moreover, the increase in the ATBC concentration to 10% in the biocomposite markedly decreases its thermal stability.

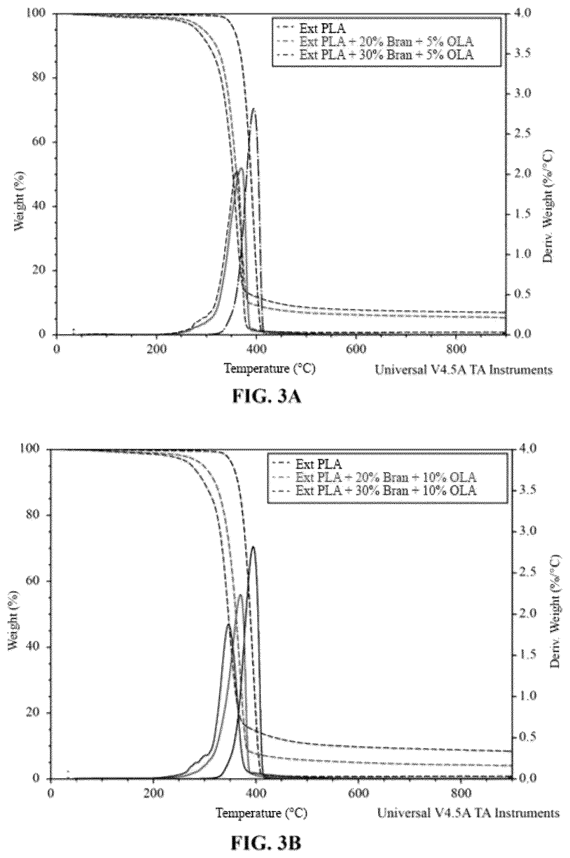

Finally, FIGS. 3A and B show TG and DTG curves of extrusion-grade PLA, wheat bran and Oligomer Lactic Acid (OLA) biocomposites in an amount of 5 and 10%, respectively.

The table below summarizes the thermal parameters tested for the biocomposite compatibilized with OLA:

TABLE 8
Thermal parameters of extrusion-grade PLA/Bran/OLA biocomposites

| No. | Tₒₙₛₑₜ (° C.) | Tₘₐₓ (° C.) | ΔW (%) | % residue |
|---|---|---|---|---|
| Extrusion-grade | 371 ± 0 | 393 ± 2 | 99.0 ± 0.2 | 0.92 ± 0.14 |
| PLA | | | | |
| 11 | 337 ± 1 | 370 ± 1 | 93.4 ± 0.3 | 5.35 ± 0.21 |
| 12 | 338 ± 2 | 369 ± 1 | 94.6 ± 1.1 | 4.96 ± 1.13 |
| 13 | 328 ± 2 | 359 ± 1 | 90.8 ± 0.8 | 7.55 ± 0.65 |
| 14 | 323 ± 3 | 353 ± 8 | 90.7 ± 0.1 | 8.73 ± 0.16 |

As with the other compatibilizing agents used, the addition of oligomeric lactic acid (OLA) to extrusion-grade PLA and wheat bran biocomposites negatively affects their thermal stability, presenting lower degradation onset temperature values (Tₒₙₛₑₜ) than that of the unreinforced extrusion-grade PLA matrix. However, it should be noted that the addition of higher concentrations (10%) of OLA does not accentuate this effect.
b. Differential Scanning calorimetry (DSC)

In order to test the thermal stability of biocomposites in more detail, a DSC analysis was performed to obtain a study of different thermal transitions observed in the materials tested.

DSC analysis of all samples, for extrusion-thermoforming and injection application was performed in a Q2000 differential scanning calorimeter (DSC) (TA Instruments®), with the purpose of measuring the difference in heat flux necessary to increase the temperature of a sample and an inert reference, based on temperature.

Samples of approximately 10 mg were used and processed under a nitrogen atmosphere, at an equilibrium temperature of 20° C., first heating from 23 to 250° C. at 10° C./min, cooling from 250° C. to 0° C. at 10° C./min and a second heating from 0° C. to 250° C. at 10° C./min.

The DSC analysis performed, allowed for determining the glass transition temperature (T_{g}), melting temperature and enthalpy (Tₘ and ΔHₘ), cold crystallization temperature and enthalpy (T_{cc} and ΔH_{cc}) and crystallinity degree (X_{c}), taking as reference the species in a 100% crystalline state.

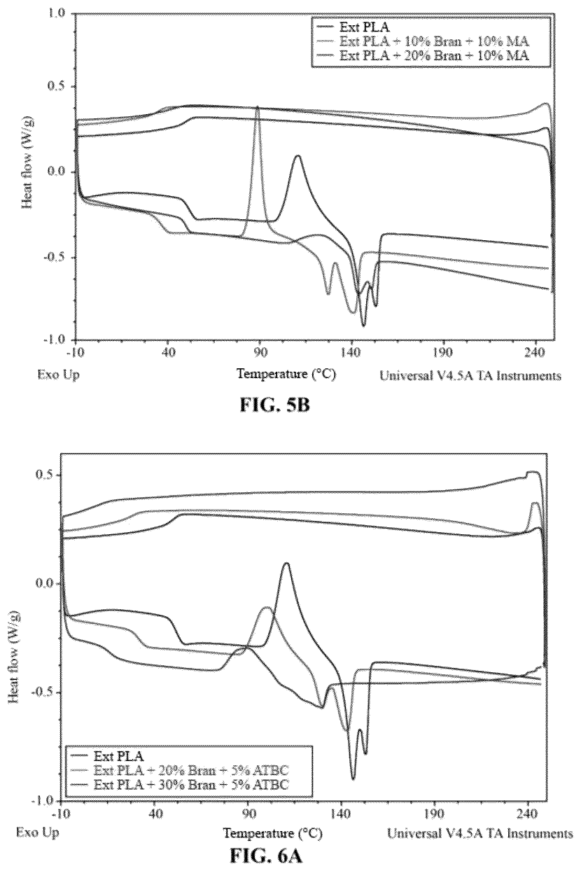

FIGS. 5 to 7 represent DSC curves of the cooling process and second heating. The curve obtained in the first heating scan is not shown since its function is to erase the thermal history of the material.

Specifically, FIGS. 5A and B show DSC curves of extrusion-grade PLA, wheat bran and Maleic Anhydride (MA) biocomposites as a compatibilizing agent in an amount of 5 and 10%, respectively.

The table below compares the main thermal parameters evaluated, T_{g}, T_{cc}, Tₘ, ΔH_{cc}, Tₘ and ΔHₘ extracted from the second heating curve of extrusion-grade PLA and wheat bran compatibilized with Maleic Anhydride (MA) biocomposites.

TABLE 9
Thermal parameters extracted from DSC curves
of extrusion-grade PLA/Bran/MA biocomposites

| | 2^{nd} Heating | | | | | |
|---|---|---|---|---|---|---|
| No. | T_{g} (° C.) | T_{cc} (° C.) | ΔH_{cc} (J/g) | T_{mI} (° C.) | T_{mII} (° C.) | ΔHₘ (J/g) |
| Extrusion- | 52 ± 1 | 112 ± 1 | 34 ± 1 | 147 ± 0 | 153 ± 0 | 37 ± 2 |
| grade PLA | | | | | | |
| 1 | 37 ± 1 | 101 ± 1 | 32 ± 1 | 131 ± 0 | 142 ± 0 | 37 ± 2 |
| 2 | 36 ± 1 | 91 ± 3 | 27 ± 1 | 128 ± 1 | 141 ± 0 | 37 ± 4 |
| 3 | 33 ± 1 | 103 ± 1 | 20 ± 1 | 129 ± 0 | 140 ± 0 | 26 ± 2 |
| 4 | 24 ± 13 | 98 | 8 | 122 | 130 | 13 |
| 5 | 48 ± 2 | 120 ± 2 | 9 ± 1 | 144 | 149 ± 2 | 11 ± 2 |
| 6 | 42 ± 9 | 123 | 8 | — | 145 | 9 |

The addition of bran and MA to the extrusion-grade PLA matrix produces a shift towards lower temperature values for glass transition (T_{g}), cold crystallization (T_{cc}) and melting (Tₘ) processes. It is worth noting the greater variability between results (standard deviation values) observed in the references with a higher bran ratio, which may be due to the difficulty of processing that these references have presented, probably due to the possible water introduced together with the bran.

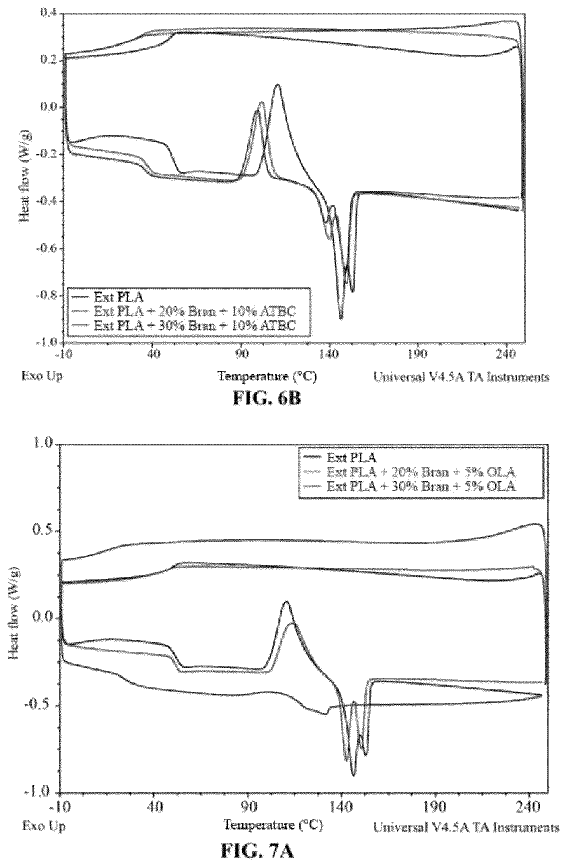

Similarly, FIGS. 6A and B show DSC curves of the Extrusion-Grade PLA/bran biocomposites compatibilized with 5 and 10% Acetyl Tributyl Citrate (ATBC), respectively. Moreover, the following table compares the previously mentioned thermal parameters:

TABLE 10
Thermal parameters extracted from DSC curves of
extrusion-grade PLA/Bran/ATBC biocomposites

| | 2^{nd} Heating | | | | | |
|---|---|---|---|---|---|---|
| No. | T_{g} (° C.) | T_{cc} (° C.) | ΔH_{cc} (J/g) | T_{mI} (° C.) | T_{mII} (° C.) | ΔHₘ (J/g) |
| Extrusion- | 52 ± 1 | 112 ± 1 | 34 ± 1 | 147 ± 0 | 153 ± 0 | 37 ± 2 |
| grade PLA | | | | | | |
| 7 | 28 ± 5 | 94 ± 10 | 22 ± 1 | 126 ± 6 | 141 ± 3 | 29 ± 5 |
| 8 | 31 ± 9 | 97 ± 6 | 21 ± 2 | 132 ± 11 | 144 ± 8 | 27 ± 2 |
| 9 | 16 ± 0 | 88 ± 2 | 14 ± 2 | 130 ± 0 | — | 15 ± 2 |
| 10 | 26 ± 15 | 88 ± 16 | 16 ± 1 | 136 ± 3 | 149 | 24 ± 1 |

The addition of higher bran ratios to a fixed concentration of compatibilizing agent (ATBC) produces a displacement of glass transition (T_{g}), cold crystallization (T_{cc}) and melting (Tₘ) processes towards lower temperature values. However, the addition of higher concentrations of compatibilizing agent into biocomposites with the same bran concentration does not produce significant changes in their thermal properties, taking into account the great variability between results.

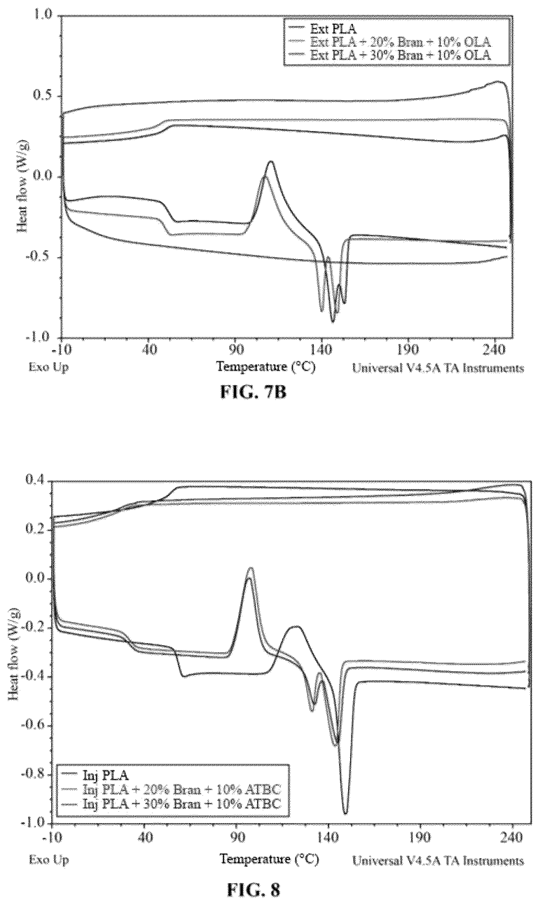

Finally, FIGS. 7A and B show DSC curves of extrusion-grade PLA, wheat bran and Oligomer Lactic Acid (OLA) biocomposites at 5 and 10%, respectively. Similarly, the following table compares the evaluated thermal parameters extracted from the second heating curve of the extrusion-grade PLA/bran biocomposites compatibilized with Oligomer Lactic Acid (OLA).

TABLE 11
Thermal parameters extracted from DSC curves
of extrusion-grade PLA/Bran/OLA biocomposites

| | 2^{nd} Heating | | | | | |
|---|---|---|---|---|---|---|
| No. | T_{g} (° C.) | T_{cc} (° C.) | ΔH_{cc} (J/g) | T_{mI} (° C.) | T_{mII} (° C.) | ΔHₘ (J/g) |
| Extrusion- | 52 ± 1 | 112 ± 1 | 34 ± 1 | 147 ± 0 | 153 ± 0 | 37 ± 2 |
| grade PLA | | | | | | |
| 11 | 51± | 116 ± 2 | 23 ± 3 | 142 ± 0 | 150 ± 0 | 26 ± 4 |
| 12 | 49 ± 0 | 111 ± 5 | 26 ± 4 | 140 ± 0 | 149 ± 0 | 29 ± 5 |
| 13 | 21 ± 4 | 107 | 4 | — | 132 | 4 |
| 14 | 46 | 125 | 6 | — | 146 | 6 |

As previously shown, the addition of OLA to the extrusion-grade PLA matrix does not produce significant changes in the thermal properties of the biocomposites, since both OLA and PLA have the same chemical nature. However, the increase in bran concentration in the biocomposite causes a displacement of the glass transition (T_{g}), cold crystallization (T_{cc}) and melting (Tₘ) processes towards lower temperature values, an effect previously observed in extrusion-grade PLA/Bran biocomposites due to the probable hydrolytic degradation of PLA chains by the action of water that remains occluded in the bran structure after drying.
Biocomposites developed for injection application.
   a. Thermogravimetric Analysis (TGA)

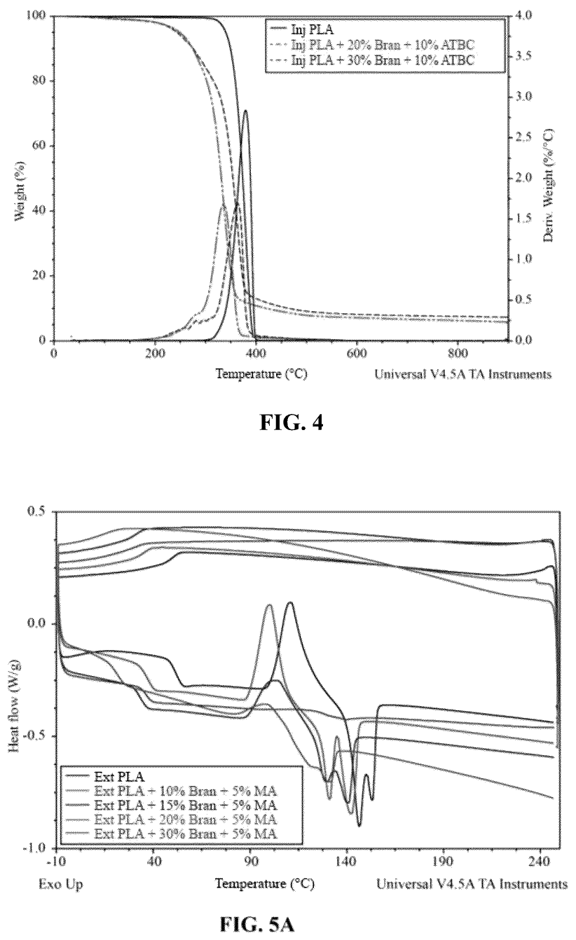

Based on the results obtained for the biocomposites for extrusion-thermoforming applications, the most promising formulations were selected for the tests to obtain biocomposites for injection applications. Therefore, formulations based on 20 and 30% wheat bran were developed, selecting Acetyl Tributyl Citrate (ATBC) as a compatibilizing agent, at a 10% concentration. FIG. 4 shows TGA thermograms (TG) and the first derivative curves (DTG) of the biocomposites obtained.

The table below compares the thermal parameters extracted from thermograms of the injection-grade PLA/bran biocomposites compatibilized with ATBC:

TABLE 12
Thermal parameters of injection-
grade PLA/Bran/ATBC biocomposites

| | Tₒₙₛₑₜ | T_{maxI} | ΔW_{I} | T_{maxII} | ΔWI_{I} | % |
|---|---|---|---|---|---|---|
| No. | (° C.) | (° C.) | (%) | (° C.) | (%) | residue |
| Injection- | 356 | — | — | 379 | 99.9 | — |
| grade PLA | | | | | | |
| 15 | 229 | 269 | 9 | 362 | 85.0 | 5.4 |
| 16 | 236 | 282 | 16 | 363 | 76.1 | 7.5 |

DTG curves of the biocomposites present two degradation processes, while for the injection-grade PLA matrix it is only possible to observe a single degradation process. The first degradation process can be associated with bran degradation and the compatibilizing agent (ATBC) and the second process, produced at higher temperature values, is attributed to degradation of the polymer matrix. The second degradation process shows how the addition of higher ratios of wheat bran improves the thermal stability of biocomposites.
b. Differential Scanning calorimetry (DSC)

Based on the results obtained for biocomposites for extrusion-thermoforming applications, the most promising formulations for injection applications were selected. FIG. 8 shows the DSC curve of injection-grade PLA biocomposites reinforced with wheat bran and compatibilized with 10% ATBC.

The table below compares the thermal parameters extracted from the second heating curve of injection-grade PLA and bran biocomposites compatibilized with 10% ATBC.

TABLE 13
Thermal parameters extracted from DSC curves of
injection-grade PLA/Bran/ATBC biocomposites

| | 2^{nd} Heating | | | | | |
|---|---|---|---|---|---|---|
| No. | T_{g} (° C.) | T_{cc} (° C.) | ΔH_{cc} (J/g) | T_{mI} (° C.) | T_{mII} (° C.) | ΔHₘ (J/g) |
| Injection- | 58 | 123 | 22.2 | — | 149 | 23.9 |
| grade PLA | | | | | | |
| 15 | 32 | 98 | 22.5 | 131 | 144 | 26.7 |
| 16 | 32 | 97 | 19.2 | 133 | 145 | 25.1 |

The results show a displacement of the glass transition (T_{g}), cold crystallization (T_{cc}) and melting (Tₘ) processes towards lower temperature values in bran biocomposites compared to the unreinforced injection-grade PLA matrix. Moreover, it is possible to observe how the melting peak in the biocomposites appears unfolded. This effect, as explained before, could be due to the plasticizing effect that Acetyl Tributyl Citrate (ATBC) contributes to the polymer matrix, added to the possible hydrolytic degradation of the polymer matrix by the action of water that is still occluded in bran after drying.

From the evaluation of thermal properties of the biocomposites tested as developed in Examples 1 to 4, it is possible to conclude that the biocomposites of the present invention are biodegradable materials under industrial compostability conditions. Biodegradable is understood to be the material that can be decomposed into natural chemical elements by the action of biological agents such as bacteria, plants, or animals, together with other physical agents such as the sun and water, under environmental conditions that occur in the nature and which transform these substances into nutrients, carbon dioxide, water, and biomass. Compostable is understood to be that material that can be degraded by the action of organisms (i.e., biologically) producing carbon dioxide, water, inorganic compounds, and biomass in a controlled period and under determined conditions (moisture, temperature and oxygen).

Moreover, it is possible to show that the PLA matrix is stable when the wheat bran included into the biocomposite does not have a moisture greater than 5%, to avoid hydrolytic degradation when mixed with the PLA polymer matrix.

For the examples developed, the comparison or blank pattern corresponds to the PLA matrix without compatibility and without the addition of bran, reaching with the biocomposites of this invention the same performance conditions as the pattern.

### Example 5: Mechanical Properties of Biocomposites Developed at Laboratory Scale

Biocomposites developed for extrusion-thermoforming application.
   a. Tensile analysis

Tensile analyses of all samples, for extrusion-thermoforming and injection application were performed in a Testometric universal testing machine model M350-20CT® (Rochdale, United Kingdom), with the purpose of determining typical mechanical parameters such as elastic modulus or Young's modulus, which defines the material rigidity, elongation at break, which indicates the ability of the material to deform before reaching the breaking point, and the maximum tensile strength defined as the ratio of maximum load supported during the tensile test to the original cross-sectional area. The tests were performed in accordance with UNE EN ISO 527-2:1997 standard with a feed rate of 20 mm/min and a distance between clamps of 50 mm.

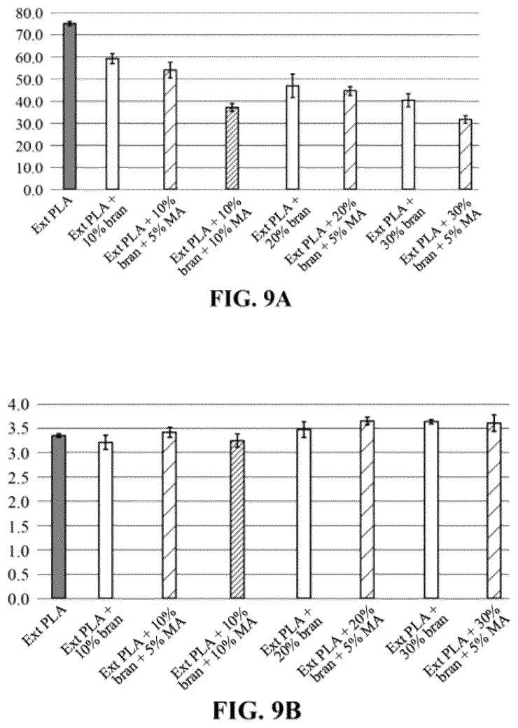

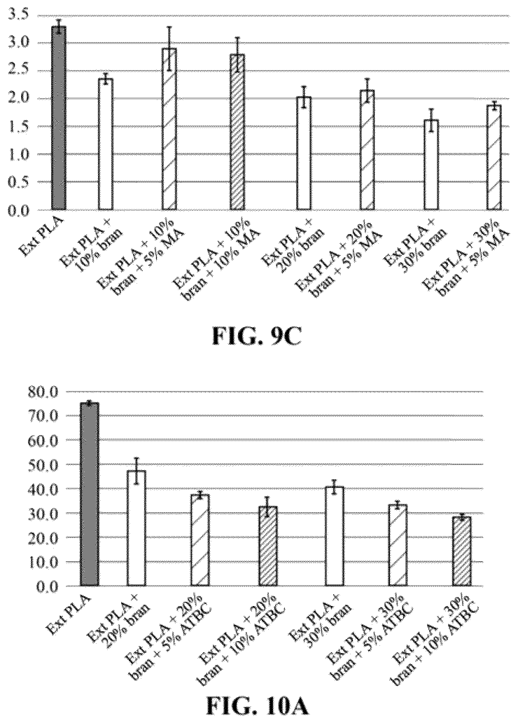

The parameters of maximum stress, Young's modulus and elongation at break were selected to evaluate the mechanical behavior of the tested samples, the last parameter (elongation at break) being the most critical for thermoforming extrusion tests. The results for the mechanical properties obtained for each of the processed biocomposites are shown in FIGS. 9 to 11.

In particular, FIGS. 9A, B and C compare the values of maximum stress, Young's modulus and elongation at break for biocomposites based on extrusion-grade PLA and wheat bran compatibilized with Maleic Anhydride (MA).

It is evident that the use of MA as a bran compatibilizing agent does not produce an increase in the values of maximum stress in the biocomposites. In a first step, the effect of two different MA concentrations was tested. However, after verifying that the use of higher concentrations of compatibilizer did not improve the mechanical properties of the biocomposites, 5% was selected as the optimal concentration to test the behavior of biocomposites with higher bran ratios. In general, the biocomposites compatibilized with MA have maximum stress values that are lower than those observed for the non-compatibilized biocomposites, which indicates that the MA has not produced the expected compatibility between reinforcement (wheat bran) and extrusion-grade PLA matrix.

Regarding the Young's modulus values, it is possible to observe a slight increase in the biocomposites compatibilized with MA, associated with rigidity of these materials. Finally, the biocomposites compatibilized with MA have slightly higher values of elongation at break than those of their homologous non-compatibilized biocomposites, an effect probably due to the plasticizing nature that MA can provide.

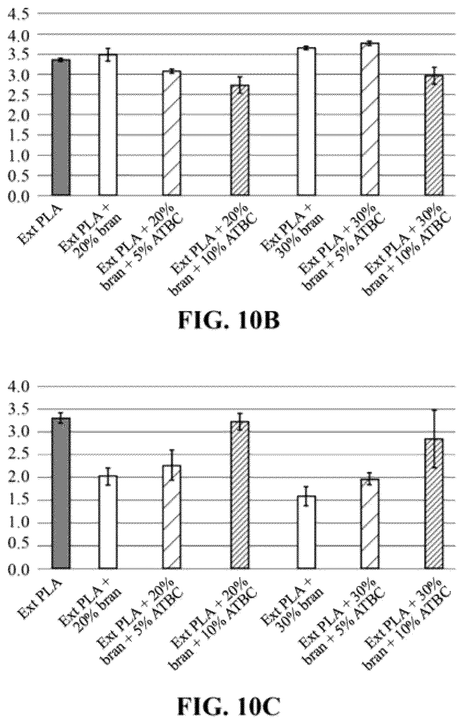

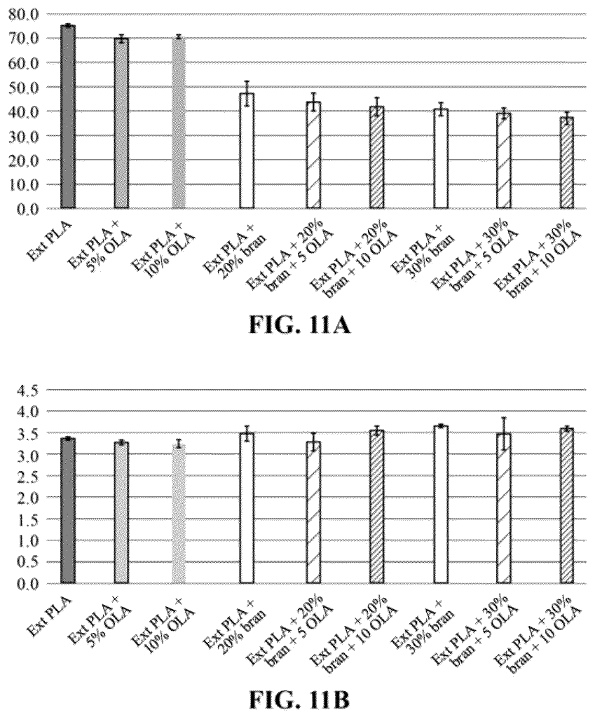

Otherwise, FIGS. 10A, B and C show values of the same mechanical parameters previously evaluated for biocomposites based on extrusion-grade PLA and bran compatibilized with Acetyl Tributyl Citrate (ATBC).

From the maximum stress results, it does not seem that the use of ATBC improves compatibility between the bran and extrusion-grade PLA matrix, as shown by the decrease observed in the maximum stress values when adding the PLA matrix with higher ratios of compatibilizing agent. However, the decrease in Young's modulus values and the increase in elongation at break observed in extrusion-grade PLA/bran/ATBC biocomposites indicate that the use of ATBC as a compatibilizing agent increases flexibility in biocomposites. This effect is much more accentuated by increasing the compatibilizing agent ratio in the biocomposite, which may be due to the plasticizing effect of this additive.

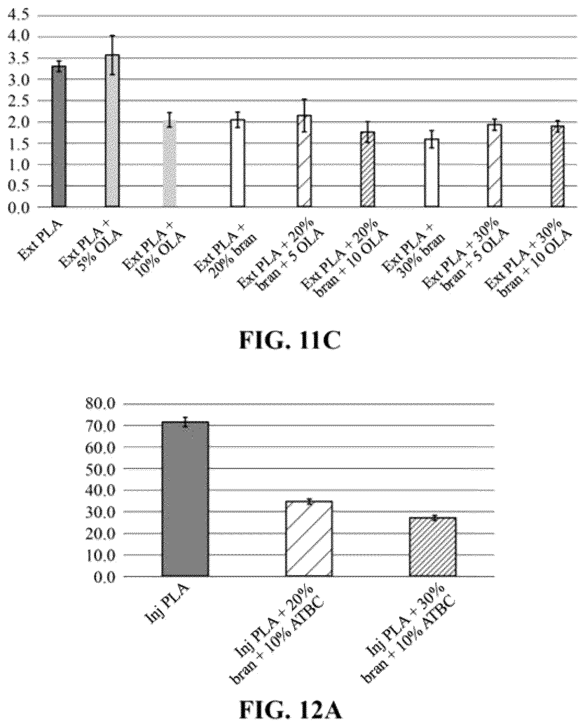

Finally, FIGS. 11A, B and C show the comparison of mechanical values already mentioned for biocomposites based on extrusion-grade PLA/wheat bran/Oligomer Lactic Acid (OLA) as compatibilizing agent.

No significant changes were observed in the mechanical properties of extrusion-grade PLA and bran biocomposites compatibilized with OLA compared to the biocomposites without additives. In general, the addition of OLA to the extrusion-grade PLA matrix does not produce significant changes in the PLA mechanical properties. It is only possible to appreciate a marked reduction in the elongation capacity at break when using higher concentrations of OLA (10%). However, by adding OLA to the PLA/Bran biocomposite, it is possible to observe a decrease in the values of maximum stress and elongation at break compared to the PLA matrix and its biocomposites without compatibilization, as well as a slight increase in Young's modulus values, associated with a greater rigidity of materials.
Biocomposites developed for injection application.
   a. Tensile analysis

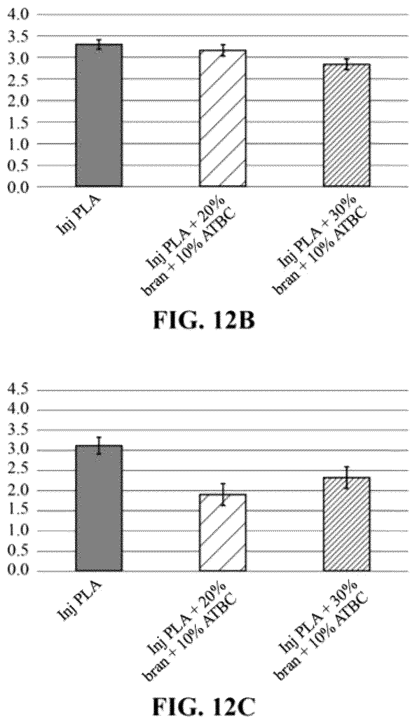

Based on the results obtained for biocomposites for extrusion-thermoforming applications, the most promising formulations have been selected for the tests to obtain biocomposites for injection applications. Therefore, formulations based on injection-grade PLA, wheat bran and ATBC as compatibilizing agent at 10% were developed. FIGS. 12A, B and C compare the values of maximum stress, Young's modulus, and elongation at break for said biocomposites.

### Example 6: Biocomposite Barrier Properties (OTR and WVTR) Developed on a Laboratory Scale

The evaluation of barrier properties was performed on the formulations selected as most promising from the previous results. Based on the barrier results obtained, a formulation will be selected for each type of application, extrusion-thermoforming, and injection, for its pilot scale study.

The equipment used for permeability tests were PERMATRAN-W model 3/34 (Mocon, Inc., Minneapolis, MN) and MOCON OX-TRAN model 2/21 ST (Mocon, Inc., Minneapolis, MN), with the purpose of determining the capacity of the material to allow the adsorption, absorption and transmission of gases, vapors and aromas based on the variables oxygen transmission rate (OTR) and permeability to O₂, water vapor transmission rate (WVTR) and water vapor permeability.

The tests were performed according to ASTM D3985-17 standard for oxygen permeability measurements and according to ASTM F1249-13 standard for water vapor permeability measurements.
Biocomposites developed for extrusion-thermoforming application.

The tables below show thickness, barrier properties (OTR, oxygen permeability, WVTR and water vapor permeability) and improvement degree of the biocomposites tested for extrusion-thermoforming applications.

TABLE 14
Thickness values, barrier properties (OTR and oxygen permeability) and improvement
degree of the biocomposites tested for extrusion-thermoforming application

| | Thickness | OTR | Permeability O₂ | % |
|---|---|---|---|---|
| No. | (μm) | (mL/m² · day) | (mL · μm/m² · day · atm) | Improvement |
| Extrusion- | 612 ± 17 | 44.8 ± 4.9 | 27478 ± 3686 | — |
| grade PLA | | | | |
| 8 | 614 ± 6 | 36.3 ± 0.5 | 22316 ± 118 | 19% |
| 10 | 623 ± 1 | 37.6 ± 0.4 | 23418 ± 294 | 15% |

TABLE 15
Thickness values, barrier properties (WVTR and water vapor permeability) and
improvement degree of biocomposites tested for extrusion-thermoforming application

| | Thickness | WVTR | Permeability O₂ | % |
|---|---|---|---|---|
| No. | (μm) | (g/m² · day) | (g · μm/m² · day) | Improvement |
| Extrusion- | 612 ± 17 | 22.9 ± 6.7 | 14180 ± 4599 | — |
| grade PLA | | | | |
| 8 | 614 ± 6 | 30.5 ± 0.3 | 18756 ± 333 | No |
| | | | | improvement |
| 10 | 623 ± 1 | 32.5 ± 3.1 | 20271 ± 1985 | No |
| | | | | improvement |

The results of Table 14 show an improvement to the oxygen barrier in the extrusion-grade PLA biocomposites reinforced with bran and compatibilized with 10% Acetyl Tributyl Citrate (ATBC) being this improvement of 19 and 15% in biocomposites reinforced with and 30% bran, respectively. Therefore, higher bran ratios in the biocomposite do not accentuate this effect.

Table 15 shows the results of water vapor barrier, in general, an improvement in the water vapor barrier is not observed in the PLA/bran/ATBC biocomposites compared to the extrusion-grade PLA matrix.
Biocomposites developed for injection application.

In the same way, the following tables show the values for thickness, barrier properties (OTR, oxygen permeability, WVTR and water vapor permeability) and the improvement degree of the biocomposites tested for injection applications.

TABLE 16
Thickness values, barrier properties (OTR and oxygen permeability) and improvement
degree of the biocomposites tested for injection application

| | Thickness | OTR | Permeability O₂ | % |
|---|---|---|---|---|
| No. | (μm) | (mL/m² · day) | (mL · μm/m² · day · atm) | Improvement |
| Injection- | 614 ± 12 | 47.6 ± 4.5 | 28999 ± 2675 | — |
| grade PLA | | | | |
| 15 | 629 ± 1 | 40.4 ± 1.0 | 25385 ± 583 | 12% |
| 16 | 637 ± 1 | 34.6 ± 1.9 | 22038 ± 1235 | 20% |

For biocomposites based on the injection-grade PLA matrix as a comparison, the permeability of injection-grade PLA blank was also measured. The results show an improvement in oxygen barrier in the bran-reinforced and compatibilized injection-grade PLA biocomposites with 10% Acetyl Tributyl Citrate (ATBC) being this improvement of 12 and 20% in biocomposites reinforced with 20 and 30% bran, respectively. Therefore, higher bran ratios in the biocomposite produce an improvement in the oxygen barrier in these biocomposites.

TABLE 17
Thickness values, barrier properties (WVTR and water vapor permeability) and
improvement degree of the biocomposite tested for injection application

| | Thickness | WVTR | Permeability O₂ | % |
|---|---|---|---|---|
| No. | (μm) | (g/m² · day) | (g · μm/m² · day) | Improvement |
| Injection- | 614 ± 12 | 13.7 ± 0.7 | 8245 ± 453 | — |
| grade PLA | | | | |
| 15 | 629 ± 1 | 26.5 ± 0.3 | 16077 ± 641 | No |
| | | | | improvement |
| 16 | 637 ± 1 | 25.2 ± 0.5 | 16053 ± 274 | No |
| | | | | improvement |

Regarding the biocomposites developed for injection applications, none of the developed formulations had an improvement in the water vapor barrier properties.

### Example 7: Biocomposite Formulation to Obtain a Packaging Prototype by Extrusion-Thermoforming

The formulations intended for development of the final product have a biocomposite with the highest possible bran ratio, without affecting the final product properties. In this sense, according to the results obtained in Examples 1 to 6 developed at laboratory scale, the following formulations were selected for pilot-scale production and obtaining a packaging prototype:

TABLE 18
Biocomposites processed on a pilot scale

| | Polymer | | | | Compatibilizing |
|---|---|---|---|---|---|
| Code | matrix | % | Reinforcement | % | agent |
| Ext Biocomposite | Extrusion- | 20 | Wheat bran | 10 | Acetyl Tributyl |
| | grade PLA | | | | Citrate (ATBC) |
| Inj Biocomposite | Injection- | 25 | Wheat bran | 10 | Acetyl Tributyl |
| | grade PLA | | | | Citrate (ATBC) |

### Example 8: Biocomposite Production Method on a Pilot Scale

The process that was performed for production of biocomposites mentioned in Example 7 comprises the following steps:
a. Bran conditioning according to Example 1
b. Drying of polymer matrix according to Example 2
c. Extrusion Processing: For the extrusion process, a co-rotating twin-screw extruder was used, with a screw diameter of 25 mm and a length-diameter (L/D) ratio of 40 D. The extruder is equipped with two gravimetric dispensers, a main one for feeding the granulated polymer and a second for dosing powder additives. It was necessary to use a dispenser for liquids to add the compatibilizing agent. The extrusion line will also have a bath to cool the biocomposite processed, a dryer and a granulator.

The temperature profile used for the processing of two selected formulations, Ext Biocomposite and Inj Biocomposite, was between 165 and 170° C. The processing speed has been maintained in all cases at 300 rpm.

The protocol for adding each one of the additives was tested with the purpose of introducing each one of the additives at the optimal moment of the process, so that the bran dispersion is adequate, the compatibilizing agent is effective and the final material is not degraded. Therefore, wheat bran is added during the extrusion process, using Brabender DDW-MD2-DSR28-10 gravimetric powder dispenser, while the compatibilizing agent Acetyl Tributyl Citrate (ATBC) was incorporated later, through the gravimetric dispenser for liquids Brabender FDDW-MD2-DZP-6.

At the end of the extrusion line, the biocomposite is obtained in the form of a thread that corresponds to the homogeneous mixture of wheat bran, ATBC and PLA. This thread, which is at a temperature of 170° C., is cooled between 20 and 30° C. passing it through a bath of water. The tangible moisture is removed from the thread obtained with a current of air to subsequently proceed to the cutting process wherein filament-type pellets are formed.

### Example 9: Characterization of Biocomposites Obtained at Pilot Scale Vs Laboratory Scale

Thermogravimetric analysis (TGA) for extrusion-thermoforming application vs. injection

The two compound references obtained (Ext Biocomposite and Inj Biocomposite) were characterized by thermogravimetric analysis, and their melt flow index (MFI) and melt density values were measured. The equipment and method used for TGA analysis corresponds to that explained in Example 4.

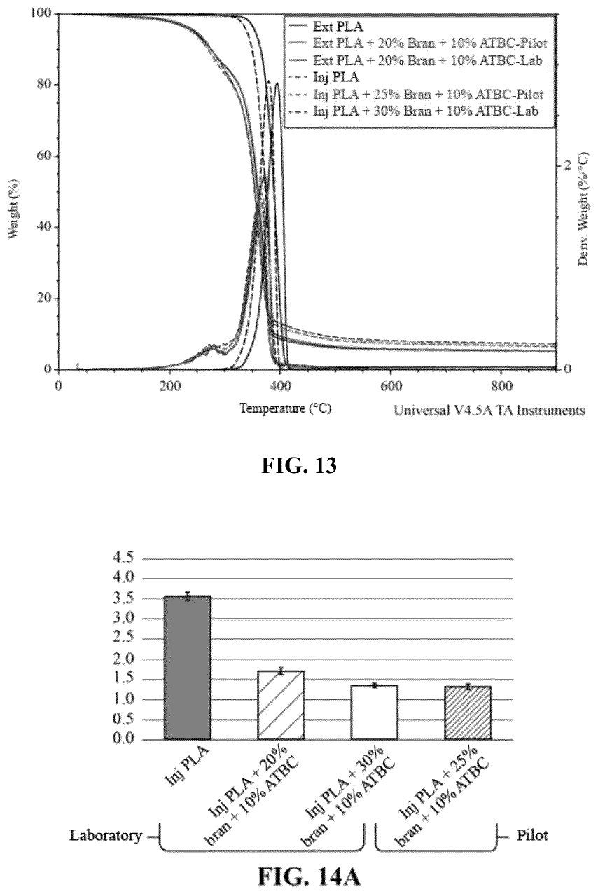

FIG. 13 shows a comparison of the thermogravimetric (TG) and first derivative (DTG) curves of biocomposites of extrusion-grade PLA+20% Bran+10% ATBC and injection-grade PLA+25% Bran+10% ATBC obtained from laboratory and pilot scale with the curves of the extrusion-grade and injection-grade PLA matrices without additives.

The following summarizes the thermal parameters of degradation onset temperature (Tₒₙₛₑₜ), maximum degradation temperature (Tₘₐₓ), total weight change produced (ΔW) and residue at the maximum induced temperature (%) extracted from the TG and DTG curves of the biocomposites:

TABLE 19
Thermal parameters extracted from TG and DTG curves of the two biocomposite
references processed at laboratory and pilot scale and that of their blanks.

| | Extrusion-grade PLA + Bran + 10% | | | Injection-grade PLA + Bran + 10% Acetyl | | |
|---|---|---|---|---|---|---|
| | Acetyl Tributyl Citrate (ATBC) | | | Tributyl Citrate (ATBC) | | |
| | PLA | Laboratory | Pilot | PLA | Laboratory | Pilot |
| | (White) | (20% Bran) | (20% Bran) | (White) | (30% Bran) | (25% Bran) |
| Tₒₙₛₑₜ (° C.) | 371 | 230 | 236 | 356 | 236 | 231 |
| T_{maxI} (° C.) | — | 277 | 279 | — | 282 | 272 |
| ΔW_{I} (%) | — | 14.5 | 15.1 | — | 16.0 | 16.9 |
| T_{maxII} (° C.) | 393 | 365 | 372 | 379 | 363 | 366 |
| ΔWI_{II} (%) | 99.0 | 79.7 | 79.3 | 99.9 | 76.1 | 76.0 |
| Residue (%) | 0.92 | 5.1 | 5.4 | 0.0 | 7.4 | 6.9 |

Flow rate and melt density for extrusion-thermoforming vs. injection application.

Moreover, the determination of melt-mass flow rate (MFR) and melt volume index (MVI) was performed, and the melt density value in accordance with UNE-EN ISO 1133-1:2012//UNE-EN ISO 1133-2:2012.

The equipment used was a GÖTTFERT MI-3 melt flow index meter to determine the melt-mass flow rate (MFR), expressed as the grams of material that flow in 10 minutes, as well as the melt volume index (MVI), expressed in cubic centimeters per 10 minutes.

A 3 to 8 g sample was used under an air or nitrogen atmosphere, a temperature of 190° C., a load of 2.16 kg and a warm-up time of 5 minutes. The standard used for this procedure was ISO 1133 part 1 and part 2.

The table below shows results of the melt-mass flow rate (MFR), melt volume index (MVI) and melt density of the biocomposites produced for extrusion-thermoforming (Ext Biocomposite) and injection (Inj Biocomposite) applications. As a comparison, the results obtained for the extrusion-grade PLA and injection-grade PLA matrices without additives are also shown.

TABLE 20
Melt mass and volume flow rate and melt density of Ext Bio-
composites and Inj Biocomposites vs. their matrices without additives.

| | Extrusion- | Ext | Injection- | Inj |
|---|---|---|---|---|
| | grade PLA | Biocomposite | grade PLA | Biocomposite |
| MFR | 2.6 ± 0.0 | 7.9 ± 0.1 | 6.3 ± 0.0 | 15.1 ± 0.3 |
| (g/10 min) | | | | |
| MVI | 2.2 ± 0.0 | 6.6 ± 0.1 | 5.4 ± 0.0 | 12.6 ± 0.2 |
| (cm)³/10 min) | | | | |
| Melt density | 1.2 ± 0.0 | 1.19 ± 0.01 | 1.2 ± 0.0 | 1.20 ± 0.01 |
| (g/cm³) | | | | |

According to the results, adding bran and ATBC to the PLA matrix produces a significant increase in the melt flow rate values of the biocomposites produced. A marked increase in the melt flow rate of a polymer can be attributed to a possible degradation of the polymer during its processing. However, the use of plasticizers, such as the ATBC used as a compatibilizing agent, also produces an increase in material flow.

Therefore, flow rate measurements of the injection-grade PLA matrix added with 10% Acetyl Tributyl Citrate (ATBC) were also performed to evaluate the individual effect of ATBC agent on the PLA matrix. The table below compares the values of mass-melt flow rate (MFR), melt volume index (MVI) and melt density of the injection-grade PLA matrix, injection-grade PLA mixture/10% ATBC and the injection-grade PLA/25% wheat bran/10% ATBC biocomposite.

TABLE 21
Melt mass and volume flow rate and melt density of the Inj bio-
composite vs matrix without additives and matrix mixture with ATBC.

| | | Injection- | |
|---|---|---|---|
| | Injection- | grade PLA | Inj Bio- |
| | grade PLA | /10ATBC | composite |
| MFR (g/10 min) | 6.3 ± 0.0 | 11.2 ± 0.4 | 15.1 ± 0.3 |
| MVI (cm³/10 min) | 5.4 ± 0.0 | 9.7 ± 0.2 | 12.6 ± 0.2 |
| Melt density (g/cm³) | 1.2 ± 0.0 | 1.1 ± 0.0 | 1.2 ± 0.0 |

The results show a marked increase in material flow as a result of the addition of ATBC to the PLA matrix, since it is a plasticizing agent. However, the fact of adding 25% wheat bran to the injection-grade PLA/10% ATBC mixture, also produces a notable increase in the final biocomposite flow, indicating a possible degradation of the polymer matrix. The combination of moisture in the bran with high temperatures reached during the biocomposite processing can generate hydrolysis reactions in the PLA matrix, causing its degradation.

### Example 10: Production Process of Packagings by Extrusion-Thermoforming

The formulation selected to manufacture packaging prototypes for extrusion-thermoforming applications was the one described in Example 7: Extrusion-grade PLA+20% Bran+10% Acetyl Tributyl Citrate (ATBC)

Once the biocomposite of said formulation had been processed according to the method described in Example 8, the packaging prototypes were obtained through the following steps:
1. Flat sheet production by extrusion process: Flat sheet processing was performed on a Dr. Collin co-extrusion line. This line is made up of three single-screw extruders coupled to a distribution block, which also allows for obtaining structures of up to five layers (ABCBA), the distribution block is connected to a head of variable thickness with a nominal width of 500 mm.

The line (CR30) is equipped for material collection with a roller with thermostatic mirror polishing on which the molten material comes into contact. Moreover, the material can be cooled by an air knife, with the option of using a secondary roller that controls the process by acting against the material take-up roller. Material tension can be controlled by torque or tensile percentage of the line winding units.

Prior to sheet production, the biocomposite obtained was dried and crystallized using two industrial dehumidifiers, respectively, for which the material was subjected to a drying time of twelve hours at 95° C. The final moisture content was validated by Karl Fisher titration, in order to prevent the material degradation during its processing, and purging was used in the hopper by means of a nitrogen stream during processing.

As a result, a sheet 600 micron thick and 400 mm wide of extrusion-grade PLA/20% wheat bran/10% ATBC was processed. The temperature profile used for the processing of the extrusion-grade PLA sheet/20% wheat bran/10% ATBC was between 175 and 200° C. The processing speed has been maintained in all cases at 150 rpm and the chill roll speed at 0.85 m/min.
2. Obtaining packaging prototypes by thermoforming the flat sheet: Once the flat sheet had been made, the packaging prototypes were manufactured by thermoforming the sheet. A semi-automatic thermoforming machine was used for this purpose, with an assisted counter-mold system. This equipment allows for the possibility of working with both male and female molds.

Two different prototypes were obtained in order to cover different final applications. To this end, a first prototype was obtained for plate-type applications, and a second smaller prototype for single-dose container-type applications for sauces.

The processing conditions used in thermoforming of the packaging prototypes for plate-type applications and single-dose container for sauces, are specified as follows:
Prototype for plate-type applications: The temperature profile used was between 65 and 70° C., with 8 seconds of heating time and 1 second of vacuum.
Prototype for single-dose container-type applications for sauces: The temperature profile used was between 65 and 70° C., with a heating time of 7 seconds and 2 seconds of vacuum.

### Example 11: Injection Packaging Production Process

For injection applications, the formulation selected to manufacture packaging prototypes was the one described in Example 7: Injection-grade PLA+25% Bran+10% Acetyl Tributyl Citrate (ATBC).

In this case, once the compound of said formulation had been processed, the packaging prototypes were obtained in a single step.

An electrically operated injection equipment of the brand was used to obtain the injection packaging prototypes. This equipment has a 45 Ton closing force, and its injection unit uses a spindle with a 22 L/D ratio and a 45 mm diameter.

Prior to manufacturing the injection packaging prototypes, the compound obtained was dried and crystallized using two industrial dehumidifiers, respectively. The material was subjected to a drying time of twelve hours at 95° C. for this purpose. The final moisture content was validated by Karl Fisher titration to prevent the material degradation during its processing.

The temperature profile used to manufacture the packaging prototypes was between 180 and 195° C. The cooling time has been maintained in all cases between 18 and 20 seconds, and the pressure during the dosing step at 100 bars.

Two different packaging prototypes were obtained to cover a greater number of final applications. In this case, a cup-type prototype suitable for different applications was obtained and, in addition, tubes of different shapes and thicknesses were injected to simulate a valid prototype for cutlery.

### Example 12: Mechanical Properties of Packagings Processed by Extrusion-Thermoforming

The mechanical properties of packaging prototypes obtained by extrusion-thermoforming were tested by compression and puncture strength tests. Moreover, the sheets obtained by extrusion were also tested through tensile tests.

The Testometric universal testing machine model M350-20CT (Rochdale, United Kingdom) was used to perform the compression test for description of material behavior when it is subjected to a compression load at a uniform speed, puncture strength test to evaluate the strength of a material to possible perforations, either due to the nature of food or due to external accidental situations and the tensile test to measure material strength to a static or slowly applied force. These tests were performed in accordance with UNE-EN ISO 604, UNE-EN 14477 and UNE EN ISO 527-2:1997 standards, respectively.
Flat-sheet tensile tests

The mechanical properties of the sheet obtained by extrusion were tested through tensile tests. The test was performed in both transverse and longitudinal directions. Values of maximum stress, Young's modulus, and elongation at break in each of the tested directions are shown in the following tables:

TABLE 22
Tensile strength results of the test performed in the transverse direction.

| Maximum | Young's | Elongation |
|---|---|---|
| stress (MPa) | modulus (GPa) | at break (%) |
| 14.3 ± 0.6 | 1.5 ± 0.1 | 2.2 ± 0.4 |

TABLE 23
Tensile strength results of the test performed
in the longitudinal direction.

| Maximum | Young's | Elongation |
|---|---|---|
| stress (MPa) | modulus (GPa) | at break (%) |
| 17.6 ± 2.1 | 1.6 ± 0.1 | 3.0 ± 0.6 |

The results show slight differences in the values obtained when performing the transversal or longitudinal test, being able to observe slightly higher values when testing the flat sheet in the longitudinal direction.
Compression test of plate-type packagings

In a compressive strength analysis, it is determined how much force a sample can withstand before deforming up to a certain value. This value is important to consider the weight that the packaging must support during storage and transport. The higher the value, the more load the packaging can support.

The table below shows the value of force necessary to deform 50% the total height (13 mm) of the packaging by compression:

TABLE 24
Compression test results of force and deformation of the plate-type-
packaging prototype by extrusion.

| | Deformation force (N) | Deformation (mm) |
|---|---|---|
| Plate-type prototype | 256 ± 24 | 5.1 ± 0.5 |
| Extrusion-grade PLA/20% | | |
| bran/10% ATBC | | |

Compression test of single-dose container-type packagings for sauces

In the same way as for the plate-type-packaging prototype, the single-dose container-type-packaging prototype for sauces was also tested by means of compression tests. The table below shows the value of force necessary to deform 50% the total height (13 mm) of the packaging by compression:

TABLE 25
Compression test results of force and deformation of the single-dose-
packaging prototype for sauces by extrusion

| | Deformation force (N) | Deformation (mm) |
|---|---|---|
| Single-dose-container | 213 ± 4 | 6.1 ± 0.1 |
| prototype for sauces | | |
| Extrusion-grade PLA/20% | | |
| bran/10% ATBC | | |

Puncture test of plate-type packagings

In addition to the compression strength tests, puncture strength analyses were also performed on the plate-type-packaging prototypes. A puncture strength test measures the strength of a sample in the form of sheet or film to punch perforation. The greater the energy required for the perforation to occur, the greater the strength of the sheet or film to perforation. Based on this analysis, it is intended to simulate a possible breakage of the base of the plate-type-packaging prototype due to fork or knife puncture.

The table below shows the values of force necessary for puncturing the base of the plate-type-packaging prototype, as well as the elongation that occurs after it breaks.

TABLE 26
Puncture strength test results of breaking force and deformation
of the plate-type-packaging prototype by extrusion.

| | Breaking | Breaking |
|---|---|---|
| | force (N) | deformation (mm) |
| Plate-type prototype | 33.4 ± 1 | 3.5 ± 0.1 |
| Extrusion-grade PLA/20% | | |
| bran/10% ATBC | | |

### Example 13: Mechanical Properties of Packagings Processed by Injection

The mechanical properties of packaging prototypes obtained by injection were tested by compression tests. Moreover, drop tests were also performed on the prototypes obtained and tensile tests on the injected test tubes.
Compression test of cup-type packagings

In addition to the formulation selected for injection applications (injection-grade PLA/25% wheat bran/10% ATBC), injection packaging prototypes were also obtained using the formulation produced for extrusion-thermoforming applications (extrusion-grade PLA/20% wheat bran/10% ATBC), since it contained a lower bran ratio and still had MFI values within the appropriate range for processing by injection.

The table below shows the maximum value of force necessary to deform the packaging by a certain percentage by compression.

TABLE 27
Compression test results of maximum force and deformation of
the cup-type-packaging prototype by injection

| | Maximum | Maximum |
|---|---|---|
| | force (N) | deformation (%) |
| Cup-type prototype | 1473 ± 131 | 3.5 ± 0.1 |
| Injection-grade PLA/25% | | |
| bran/10% ATBC | | |
| Cup-type prototype | 2241 ± 134 | 4.0 ± 0.3 |
| Extrusion-grade PLA/20% | | |
| bran/10% ATBC | | |

Impact test by free fall of cup-type packagings

The drop test was performed based on the UNE EN 22248 standard, which aims to determine the strength of complete packagings to a free-fall vertical shock, being closed and filled with the products they are going to contain. The test consists of lifting the packaging to a certain height above a rigid surface and then releasing it so that it falls on this surface (called the “impact surface”). For this purpose, it is necessary to define the conditions to prepare the packaging, drop height, food to contain and position of the packaging.

In the case of cup-type-packaging prototypes obtained by injection, creamy yogurt was selected as the food to contain, the packaging was placed resting on its base and closed with adhesive aluminum film and was previously conditioned at 23° C. and 50% relative moisture. Finally, various heights were defined, considering the heights of supermarket shelves and the possibility of the packaging falling out of someone's hands. The selected heights were 60, 80, 100 and 120 cm. For each of the heights, three replicates of the test were performed.

The behavior of the two references processed for this packaging prototype was evaluated. The table below shows the results obtained for each of them, indicating the number of replicates that have passed the test vs. the total number of replicates tested.

TABLE 28
Results of free fall test of cup-type-packaging prototypes by injection

| | 120 cm | 100 cm | 80 cm | 60 cm |
|---|---|---|---|---|
| Cup-type prototype | 0/3 | 0/3 | 0/3 | 1/3 |
| Injection-grade PLA/25% | | | | |
| bran/10% ATBC | | | | |
| Cup-type prototype Extrusion-grade | 0/3 | 2/3 | 3/3 | 3/3 |
| PLA/20% bran/10% ATBC | | | | |

The results show significant differences between both references, highlighting that the reference with a higher bran percentage does not pass the test at any of the selected heights. In the referenced case with 20% bran, the maximum height exceeded is 100 cm.
Tensile test of tube-type packagings

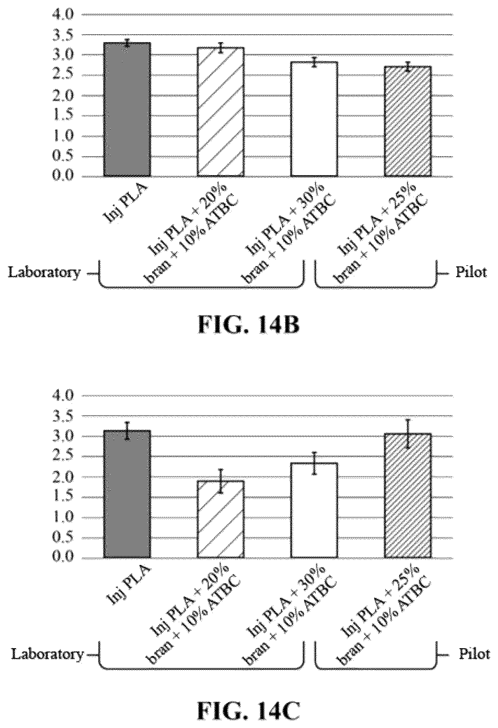

Finally, the mechanical properties of the injected tubes were tested through tensile tests. The results obtained for the processed tubes are compared with those obtained for the tubes manufactured on a laboratory scale to have a comparison. These results are evidenced in FIGS. 14A, B and C, wherein the comparison for the values of maximum stress, Young's modulus and elongation at break is shown.

The results do not show significant differences between the materials obtained at laboratory and pilot scale. Moreover, it is possible to observe a slight increase in the elongation values at break in the injection-grade PLA/25% wheat bran/10% ATBC sample processed at pilot scale, indicating a lower stiffness in the biocomposites probably due to a better dispersion of the reinforcement in the polymer matrix.

According to the results obtained in the previous examples, it is evident that the thermal stability properties of the biocomposites processed both on a pilot and laboratory scale yielded positive results for this development, showing that the addition of a compatibilizing agent and particularly ATBC generates a plasticizing effect that allows for a significant increase in the melt flow rate. An particular, the compatibilizing agent allows for the mixture to occur and at the same time gives it stability, so that the elements that make up the biocomposite behave as if they were truly miscible with each other, i.e., the compatibilizing agent generates a significant improvement in the final result since it facilitates the homogeneous mixing process, even though individual phases of each of the types of resins with their properties still coexist therein. Moreover, the increase in material flow was also evident when adding higher bran concentrations. Generating a homogeneous dispersion of the components, thus achieving a greater biocomposite optimization.

Regarding the thermal resistance of the biocomposites processed, it is possible to observe a decrease in their thermal stability by increasing the bran ratio in the biocomposite. Therefore, it seems that the ideal bran percentage corresponds to 25% to guarantee the functional characteristics of the biocomposite.

The DSC results showed a possible degradation of the PLA polymer matrix at high bran contents in the biocomposite (>40%), probably due to high water content (>13% moisture) that still contains the wheat bran therefrom without any conditioning. This fact can produce the hydrolytic degradation of PLA during biocomposite processing.

Therefore, it is an initial requirement to conditioning wheat bran to bring it to its optimal processing conditions. This guarantees that it will not have hydrolytic degradation effects.

In general, the use of compatibilizing agents produces a plasticizing effect on the polymer matrix due to the low molecular weight of these additives, which favors the mobility of PLA chains and improves the mixing process of the two components of the formulation (PLA+Wheat Bran).

On the other hand, the use of a compatibilizing agent, preferably ATBC, produced an improvement in mechanical properties of the biocomposites developed, observing an increase in the elongation values at break with respect to the PLA matrix without additives. In addition, oxygen barrier properties were also favored in the biocomposites added with a compatibilizing agent. In the case of biocomposites based on the extrusion-grade PLA, the increase of bran in the composition does not improve the oxygen barrier. However, those based on the injection-grade PLA do improve the barrier by increasing a higher bran ratio in the biocomposite.

On the other hand, the conditioning step of wheat bran used as reinforcing material favored the interaction between the elements that make up the biocomposite, as previously mentioned. As moisture decreases, it favors that a hydrolytic degradation of the material does not occur, improving the final conditions of the product. Moreover, the decrease in bran granulometry facilitates its incorporation into the polymer matrix, achieving a homogeneous dispersion of the biocomposite.

Finally, the tests developed on the packagings manufactured demonstrate that the biocomposites developed can be satisfactorily processed for use as materials to manufacture containers in general, with the advantage that all the materials used for the formulation of biocomposites are compostable and/or biodegradable, whose origin is from a renewable source and therefore it is expected that the final material complies with industrial compostability standard UNE-EN 13432:2001. In terms of i) characterization of materials, wherein a minimum content of organic matter is required (>50%) and the maximum levels of regulated metals and other hazardous substances; ii) biodegradation, wherein compostable packagings are required to be completely biodegradable. Biodegradability is preferably tested according to ISO 14855; iii) disintegration, defined as the physical and visual disappearance of a specific shape (with a maximum thickness) of the packagings. This can be tested in a pilot-scale-composting test (ISO 16929) or in a laboratory-scale-composting test (ISO 20200) in some specific cases; and iv) compost quality, assessed by means of physical-chemical analysis and also by plant toxicity tests (OECD 208) determining germination and growth.

1. A biocomposite comprising a polymer matrix, a bran reinforcement, and a compatibilizing agent.

2. The biocomposite according to claim 1, wherein the bran reinforcement is selected from oat bran, spelt, rice, rye, wheat, corn, millet, bulgur, barley, quinoa or amaranth, or a combination thereof.

3. The biocomposite according to claim 1, wherein the polymer matrix is polylactic acid (PLA), cellulose, polybutylene succinate (PBS), chitosan, polycaprolactone (PCL) or polyhydroxyalkanoate (PHA).

4. The biocomposite according to claim 3, wherein the polymer matrix is extrusion-, injection- or compression-molding grade.

5. The composite according to claim 1, wherein the compatibilizing agent is selected from maleic anhydride (C₄H₂O₃), acetyl tributyl citrate (ATBC) and oligomeric lactic acid (OLA).

6. The biocomposite according to claim 1, which optionally comprises additives selected from colorants, plasticizers, processing aids and flame retardants.

7. The biocomposite of claim 1, wherein the bran reinforcement has a particle size between 0.1 and 0.7 mm and a residual moisture between 1 and 5%.

8. The biocomposite according to claim 1, wherein the polymer matrix is between and 94% w/w, the bran reinforcement is between 1 and 70% w/w, and the compatibilizing agent is between 1 and 20% w/w.

9. The biocomposite according to claim 1, characterized in that it comprises between and 85% w/w of polymer matrix, between 1 and 30% w/w of bran reinforcement and between 5 and 15% w/w of compatibilizing agent.

10. The composite according to claim 1, comprising PLA as a polymer matrix, wheat bran reinforcement and ATBC as a compatibilizing agent.

11. The biocomposite according to claim 10, comprising between 60 and 75% PLA, between 1 and 30% wheat bran reinforcement and between 5 and 15% ATBC.

12. The biocomposite according to claim 1, characterized in that:
a melt-mass flow rate (MFR) between 6 and 15 g/10 min,
a melt volume index (MVI) between 6 and 13 cm³/10 min,
a melt density between 1 and 1.3 g/cm³,
a degradation onset temperature Tₒₙₛₑₜ between 230 and 240° C., a maximum degradation temperature Tₘₐₓ between 270 to 280° C.

13. Use of the biocomposite according to claim 1 to manufacture packagings, containers, cutlery, trays, and utensils.

14. A method to produce a biocomposite according to claim 1, comprising:
a) heating a polymer matrix at a temperature between 165 and 170° C. until obtaining the molten matrix;
b) adding a compatibilizing agent to the molten matrix from step a) at a temperature between 170 and 180° C.;
c) adding to the mixture of step b) a bran reinforcement at a temperature between 170 and 180° C.;
d) cooling the mixture from step c) to room temperature;
e) drying and granulating;
wherein steps a) to c) are performed at a speed between 250 and 350 rpm.

15. The method of claim 14, wherein the polymer matrix has a moisture maximum of 250 ppm.

16. The method of claim 14, wherein the bran reinforcement has a particle size of less than 0.5 mm and a residual moisture of less than or equal to 3%.

17. The method of claim 14, wherein the process is preferably performed in a twin-screw extruder.
